(19) United States
(12) Patent Application Publication
(10) Pub. No.: US 2011/0028312 A1
(43) Pub. Date: Feb. 3, 2011

(54) METHOD FOR RECOVERING MOLYBDENUM AND COBALT

(75) Inventors: Naoki MIURA, Ehime (JP); Eiichi SHIRAISHI, Ehime (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/838,856

(22) Filed: Jul. 19, 2010

(30) Foreign Application Priority Data
Jul. 31, 2009 (JP) 2009-179452

(51) Int. Cl. B01J 23/882; C22B 23/00; C22B 34/34

(52) U.S. Cl. 502/313; 75/711

(57) ABSTRACT

There are disclosed a method for recovering both of molybdenum and cobalt at once with a sufficiently high recovery, and a method for producing a composite oxide, etc., using molybdenum and cobalt recovered by the above method. In this method for recovering molybdenum and cobalt, a composite oxide containing molybdenum and cobalt is mixed with an aqueous extracting solution obtained by dissolving at least one of ammonia and an organic base in water, to thereby extract, from the composite oxide, molybdenum and cobalt into an aqueous phase. In the method for producing a composite oxide, the above aqueous phase containing molybdenum and cobalt is dried and is then calcined.

### TECHNICAL FIELD

The present application claims the Paris Convention priority based on Japanese Patent Application No. 2009-179452 filed on Jul. 31, 2009, the entire content of which is incorporated herein by reference.

The present invention relates to a method for recovering molybdenum and cobalt from a composite oxide containing molybdenum and cobalt, and to a method for producing a composite oxide or a composite oxide catalyst, using the molybdenum and cobalt recovered by the above-described method, as raw materials.

Composite oxides containing molybdenum and cobalt conventionally have been widely used as catalysts for a variety of catalytic gas phase oxidation reactions. Generally, catalysts tend to degrade in their performance after used over a given period of time, and are then discarded as waste catalysts. Therefore, there arises a demand for recovering and recycling molybdenum and cobalt in such waste catalysts. As a method for recovering both of molybdenum and cobalt, there is proposed the method for recovering molybdenum and cobalt, respectively, as follows (Patent Publication 1): that is, a composite oxide containing molybdenum and cobalt is leached in an aqueous solution of an alkali such as caustic soda or sodium carbonate to obtain a leachate containing molybdenum; and the insoluble residue is leached in an aqueous solution of sulfuric acid to obtain a leachate containing cobalt. There is also proposed the method for recovering molybdenum, by mixing a composite oxide which contains molybdenum and cobalt, with an aqueous solution of alkali hydroxide, to obtain an aqueous solution containing molybdenum, so as to recover molybdenum (Patent Publication 2).

### PRIOR ART LITERATURE

### Patent Publications

Patent Publication 1: JP-A-5-156375

Patent Publication 2: International Laid-Open
Publication No. 2007/032228

### SUMMARY OF THE INVENTION

### Problem to be Solved by the Invention

However, in any of the conventional methods for recovering molybdenum and cobalt, described above, firstly, molybdenum is recovered, and then, cobalt is recovered from the residue. While these recovering methods are advantageous in case where the recovered molybdenum and cobalt are separately recycled, such methods are disadvantageous in view of facility and cost-effectiveness, since a number of steps are required for recovery. In the meantime, there are a lot of catalysts which contain both of molybdenum and cobalt as catalyst constitutive elements. In some cases, a method for recovering both of molybdenum and cobalt at once is advantageous so as to recycle molybdenum and cobalt as raw materials for such catalysts. Thus, a demand for such a method has been increasing.

Objects of the present invention are therefore to provide a method for recovering both of molybdenum and cobalt at once at a higher recovery, and to provide a method for producing a composite oxide and a method for producing a composite oxide catalyst, using as raw materials the molybdenum and cobalt recovered by the above-described method.

### Means for Solving the Problem

As a result of the present inventor's intensive studies for solving the foregoing problem, the following is found out: the use of an aqueous alkaline solution obtained by dissolving at least one of ammonia and an organic base in water is effective to extract both of molybdenum and cobalt into an aqueous phase at a sufficiently high recovery, while the use of an aqueous solution of an alkali, i.e., a base such as caustic soda or sodium carbonate, used in the above-described conventional methods for recovering molybdenum and cobalt, is hard to extract cobalt with the aqueous solution at a sufficiently high recovery. The present invention is accomplished based on such a finding.

That is, the present invention provides the following.

(1) A method for recovering molybdenum and cobalt, characterized in that a composite oxide containing molybdenum and cobalt is mixed with an aqueous extracting solution obtained by dissolving at least one of ammonia and an organic base in water, to thereby extract, from the composite oxide, molybdenum and cobalt into an aqueous phase.
(2) The method defined in the above item (1), wherein the composite oxide contains cesium together with molybdenum and cobalt, and wherein cesium is also extracted into the aqueous phase.
(3) The method defined in the above item (1) or (2), wherein the pH of the aqueous extracting solution is 8 or more.
(4) The method defined in any one of the above items (1) to (3), wherein a temperature for mixing the composite oxide with the aqueous extracting solution is from 0 to 100° C.
(5) The method defined in any one of the above items (1) to (4), wherein the organic base is at least one of an amine or a quaternary ammonium compound.
(6) A method for producing a composite oxide which contains molybdenum and cobalt, characterized in that the aqueous phase containing molybdenum and cobalt, obtained by the recovering method defined in any one of the above items (1) to (4), is dried and is then calcined.
(7) A method for producing a composite oxide catalyst which contains molybdenum and cobalt and which is at least one composite oxide catalyst selected from the group consisting of a catalyst for production of unsaturated aldehyde and unsaturated carboxylic acid, a catalyst for production of unsaturated carboxylic acid, a catalyst for production of unsaturated nitrile, and a catalyst for hydrotreatment, characterized in that the molybdenum and cobalt contained in the aqueous phase obtained by the recovering method defined in any one of the above items (1) to (4) are used as raw materials for the catalyst; and in that an aqueous solution or aqueous slurry, containing the raw materials for the catalyst, is dried and is then calcined.
(8) The production method defined in the above item (7), for a catalyst for production of unsaturated aldehyde and unsaturated carboxylic acid.
(9) The production method defined in the above item (7) or (8), wherein, after the calcination, the resulting catalyst is subjected to a heat treatment in the presence of a reducing material.
(10) The production method defined in the item (9), wherein the heat treatment is carried out at a temperature of from 200 to 600° C.
(11) The production method defined in the item (9) or (10), wherein a rate of decrease in mass attributed to the heat treatment is from 0.05 to 6% by mass.
(12) The production method defined in any one of the items (9) to (11), wherein the reducing material is selected from the group consisting of hydrogen, ammonia, carbon monoxide, C₁₋₆ hydrocarbons, C₁₋₆ alcohols, C₁₋₆ aldehydes and C₁₋₆ amines.

### Effect of the Invention

According to the present invention, it becomes possible to recover both of molybdenum and cobalt at once at a higher recovery, so that a composite oxide or a composite oxide catalyst, containing molybdenum and cobalt, can be produced at a lower cost by recycling such materials recovered by a simple method.

### MODES FOR CARRYING OUT THE INVENTION

Hereinafter, the present invention will be described in detail.

### Method for Recovering Molybdenum and Cobalt

The method for recovering molybdenum and cobalt, according to the present invention, is intended to recover molybdenum and cobalt from a composite oxide containing molybdenum and cobalt.

The composite oxide to be used in the recovering method of the present invention is not limited, in so far as the composite oxide contains molybdenum and cobalt. It may be, for example, a composite oxide which contains molybdenum and cobalt alone, or a composite oxide which contains at least one other metal element as a constitutive element, in addition to molybdenum and cobalt. As other metal element, there are exemplified bismuth, iron, nickel, manganese, zinc, calcium, magnesium, tin, lead, phosphorus, boron, arsenic, tellurium, tungsten, antimony, silicon, aluminum, titanium, zirconium, cerium, potassium, rubidium, cesium, thallium, vanadium, copper, silver, lanthanum, etc.

A preferable composition of the above-described composite oxide is represented by the following formula (1):

MoaBibFecCodAeBfCgOx (1).

In the formula (1), Mo, Bi, Fe and Co represent molybdenum, bismuth, iron and cobalt, respectively; A represents an element selected from the group consisting of nickel, manganese, zinc, calcium, magnesium, tin and lead; B represents an element selected from the group consisting of phosphorus, boron, arsenic, tellurium, tungsten, antimony, silicon, aluminum, titanium, zirconium and cerium; C represents an element selected from the group consisting of potassium, rubidium, cesium and thallium; and O represents oxygen, wherein the following equations are satisfied when a is 12 (a=12): 0<b≦10, 0<c≦10, 1≦d≦10, 0≦e≦10, 0≦f≦10 and 0<g≦2; and x is a value which is determined by the oxidized states of the respective elements.
Among the composite oxides of the formula (1), the composite oxides of any of the following formulas (from which oxygen atoms are extruded) are preferable:

Mo12Bi0.1-5Fe0.5-5Co5-10Cs0.01-1, and

Mo12Bi0.1-5Fe0.5-5Co5-10Sb0.1-5K0.01-1.

The above-described composite oxide may be a unused composite oxide or may be a composite oxide which already has been used as a catalyst or the like, or may be a composite oxide which has no required performance as a catalyst although produced as a catalyst (such a composite oxide is, for example, a composite oxide powdered during production thereof, or a composite oxide which has degraded due to a thermal load or the like). The type of a catalyst usable as the above-described composite oxide is not limited. Examples of such a catalyst include catalysts for hydrotreatments such as a catalyst for desulfuration of heavy oil or the like, a catalyst for denitrification of heavy oil or the like, a reforming catalyst (for hydrogenolysis) of heavy oil or the like and a catalyst for hydrogenation of heavy oil or the like, in addition to a catalyst for production of unsaturated aldehyde and unsaturated carboxylic acid, a catalyst for production of unsaturated carboxylic acid and a catalyst for production of unsaturated nitrile.

In the method for recovering molybdenum and cobalt, according to the present invention, any of the above-described composite oxides is mixed with an aqueous extracting solution of at least one of ammonia and an organic base (i.e., a basic component) in water. By this mixing, molybdenum and cobalt are extracted from the composite oxide into the aqueous phase of the aqueous extracting solution at a high recovery (or extraction percentage).

When the above-described basic component is ammonia, a compound which is decomposed to form ammonia (hereinafter optionally referred to as “an ammonia-forming material”) may be dissolved in water, instead of ammonia. As the ammonia-forming material, there are exemplified ammonium carbonate, ammonium bicarbonate, urea, etc. As the ammonia-forming material, each of these materials may be used alone, or two or more selected therefrom may be used in combination.

When the above-described basic component is an organic base, there are exemplified, as the organic base, saturated aliphatic amines such as methylamine, dimethylamine, trimethylamine, ethylamine, diethylamine and triethylamine; unsaturated aliphatic amines such as allylamine, diallylamine and triallylamine; amines such as aromatic amine (e.g., aniline); quaternary ammonium compounds such as hydroxides or halides of quaternary ammonium, e.g. tetramethylammonium, tetraethylammonium, n-propyltrimethylammonium, tetra-n-propylammonium, tetra-n-butylammonium, 4,4′-trimethylenebis(dimethylpiperidium), benzyltrimethylammonium, dibenzyldimethylammonium, 1,1′-butylenebis(4-aza-1-azoniabicyclo[2,2,2]octane) and trimethyladamantyl ammonium; pyridine; pyrimidine; etc. The use of at least one selected from the amines and the quaternary ammonium compounds among those organic bases is preferable. Any of these organic bases may be used alone, or two or more selected therefrom may be used in combination.

The number of moles of the basic component to be dissolved in the aqueous extracting solution should be larger than the number of total moles of molybdenum and cobalt in the composite oxide to be mixed with the aqueous extracting solution. Specifically, a ratio of the number of moles of the basic component to the number of the total moles of molybdenum and cobalt is preferably 1 or more, more preferably 2 or more.

As the aqueous extracting solution, an aqueous ammonia solution is preferably used from the viewpoint of cost.

The pH of the aqueous extracting solution is preferably 8 or more. When the pH of the aqueous extracting solution is less than 8, the recovery of molybdenum and cobalt tends to be insufficient.

The temperature for mixing the composite oxide with the aqueous extracting solution is preferably from 0 to 100° C., more preferably from 10 to 80° C. The mixing time may be appropriately selected in accordance with the mixing temperature, etc., and it is usually from one minute to 100 hours, preferably from 1 to 24 hours.

The order and method for mixing the composite oxide and the aqueous extracting solution are not limited. For example, to one of the aqueous extracting solution and the composite oxide, the other one may be added; or to one of the aqueous extracting solution and a previously prepared aqueous dispersion of the composite oxide in water, the other one may be added; or at least one of ammonia (or an ammonia-forming material) and an organic base may be dissolved in a previously prepared aqueous dispersion of the composite oxide in water. Preferably, the composite oxide should be ground before the mixing.

In the method for recovering molybdenum and cobalt, according to the present invention, as a result of the mixing of the composite oxide with the aqueous extracting solution, there are obtained an aqueous phase containing the extracted molybdenum and cobalt (hereinafter optionally referred to as “a molybdenum-and-cobalt-containing aqueous solution”) and a solid residue derived from the composite oxide. The molybdenum-and-cobalt-containing aqueous solution and the residue, thus recovered, are obtained usually as slurry. Therefore, this slurry is separated by filtration such as decantation, gravity-filtration, filtration under reduced pressure, pressure filtration or centrifugal filtration, to thereby obtain only the molybdenum-and-cobalt-containing aqueous solution. When ammonia is used as the basic component, this ammonia can be separately recovered for recycling.

In the method for recovering molybdenum and cobalt, according to the present invention, the molybdenum-and-cobalt-containing aqueous solution may be obtained as the recovered material; or the molybdenum-and-cobalt-containing aqueous solution may be further dried and subjected to a heat treatment or the like to thereby obtain a solid material as the recovered material.

The recovering method of the present invention makes it possible to recover especially molybdenum and cobalt at a higher recovery. If the composite oxide contains cesium in addition to molybdenum and cobalt, the recovering method of the present invention also makes it possible to efficiently extract cesium into the above-described aqueous phase, so that cesium can be recovered at a sufficiently high recovery.

### Method for Producing Composite Oxide Containing Molybdenum and Cobalt

In the method for producing a composite oxide which contains molybdenum and cobalt, according to the present invention, the molybdenum-and-cobalt-containing aqueous solution obtained by the above-described recovering method of the present invention is dried and is then calcined to thereby obtain a composite oxide which contains at least molybdenum and cobalt.

In the method for producing a composite oxide, according to the present invention, the molybdenum-and-cobalt-containing aqueous solution obtained by the above-described recovering method of the present invention may be singly dried and calcined; or, a material compound for introducing a different metal element other than molybdenum and cobalt may be added to the molybdenum-and-cobalt-containing aqueous solution at appropriate timing, i.e., before drying (in the state of the aqueous solution) or before calcination (in the state of the dried solid). When such a material compound is added to introduce a different metal element other than molybdenum and cobalt, it becomes possible to control the composition rate of the resultant composite oxide to a desirable one. The composition of a composite oxide to be obtained by the composite oxide-producing method of the present invention may be the same as or different from that of the composite oxide used in the above-described recovering method of the present invention.

As the material compound for introducing a different metal element other than molybdenum and cobalt, there may be used the compounds of other metal elements, described as the constitutive elements of the composite oxides to be used in the section of “Method for Recovering Molybdenum and Cobalt”, and examples of such compounds include oxides, nitrates, sulfates, carbonates, hydroxides, oxo acids and ammonium salts of the same acid, and halides.

In this regard, a material compound for introducing molybdenum or cobalt may be added when the different metal element other than molybdenum and cobalt is introduced, in order that the composition rate of the resultant composite oxide may be controlled. As the material compound for introducing molybdenum, there are exemplified molybdenum compounds such as molybdenum trioxide, molybdic acid and ammonium paramolybdate. As the material compound for introducing cobalt, there are exemplified cobalt compounds such as cobalt nitrate and cobalt sulfate.

In the composite oxide-producing method of the present invention, the drying conditions and the calcination conditions are not limited, and thus may be appropriately selected according to a known method for producing a composite oxide or a composite oxide catalyst.

### Method for Producing Composite Oxide Catalyst

In the method for producing a composite oxide catalyst, according to the present invention, molybdenum and cobalt contained in the aqueous phase (i.e., the molybdenum-and-cobalt-containing aqueous solution) obtained by the above-described recovering method of the present invention are used as materials for a catalyst. An aqueous solution or aqueous slurry, containing these materials, is dried and is then calcined, to thereby obtain a composite oxide catalyst which contains at least molybdenum and cobalt.

In the composite oxide catalyst-producing method of the present invention, aqueous slurry or an aqueous solution may be prepared by adding other material compound for catalyst, to the molybdenum-and-cobalt-containing aqueous solution obtained by the recovering method of the present invention; or the molybdenum-and-cobalt-containing aqueous solution may be once dried to obtain a dried material, which may be then mixed with water and other material compound for catalyst, to prepare aqueous slurry or an aqueous solution thereof.

Other material compound for catalyst, to be used in the composite oxide catalyst-producing method of the present invention, may be the same one as any of the material compounds described in the section of “Method for Producing Composite Oxide Containing Molybdenum and Cobalt”. The amount of this material compound may be appropriately selected in accordance with the composition of a desired catalyst. Again, to control the composition of the catalyst to be desirable, a molybdenum compound or a cobalt compound may be used as a material compound, as well as in the above-described composite oxide-producing method.

In the composite oxide catalyst-producing method of the present invention, the conditions for preparing the aqueous slurry or the aqueous solution and the conditions for calcining and baking the aqueous slurry or the aqueous solution are not limited. The known conditions may be selected for the present catalyst-producing method, according to the type (or use) of a desired catalyst. When an intended composite oxide catalyst is, for example, a catalyst for production of unsaturated aldehyde and unsaturated carboxylic acid, the procedure and conditions disclosed in JP-A-2007-117866, JP-A-2007-326787, JP-A-2008-6359, JP-A-2008-231044 or the like may be appropriately selected. When an intended composite oxide catalyst is a catalyst for production of unsaturated nitrile, the procedure and conditions disclosed in JP-B-48-43096, JP-B-59-16817 or the like may be appropriately selected. When an intended composite oxide catalyst is a catalyst for hydrotreatment, the procedure and conditions disclosed in JP-A-59-69149, Patent Registration No. 3599265, Patent Registration No. 1342772, Patent Registration No. 2986838, JP-A-2007-152324 or the like may be appropriately selected.

In the composite oxide catalyst-producing method of the present invention, preferably, the dried aqueous phase is calcined and is then subjected to a heat treatment in the presence of a reducing material (hereinafter optionally simply referred to as “reduction treatment”). Because of this reduction treatment, the catalytic activity of the resultant catalyst can be effectively improved. This effect is found to be remarkable especially in the production of a catalyst for production of unsaturated aldehyde and unsaturated carboxylic acid.

As the above-described reducing material, there are exemplified hydrogen, ammonia, carbon monoxide, hydrocarbons, alcohols, aldehydes and amines as preferable ones. Preferable herein are C₁₋₆ hydrocarbons, C₁₋₆ alcohols, C₁₋₆ aldehydes and C₁₋₆ amines. Examples of the C₁₋₆ hydrocarbons include saturated aliphatic hydrocarbons such as methane, ethane, propane, n-butane and isobutane; unsaturated aliphatic hydrocarbons such as ethylene, propylene, α-butylene, β-butylene and isobutylene; and benzene. Examples of the C₁₋₆ alcohols include saturated aliphatic alcohols such as methyl alcohol, ethyl alcohol, n-propyl alcohol, isopropyl alcohol, n-butyl alcohol, isobutyl alcohol, secondary butyl alcohol and tertiary butyl alcohol; unsaturated aliphatic alcohols such as allyl alcohol, crotyl alcohol and methallyl alcohol; and phenols. Examples of the C₁₋₆ aldehydes include saturated aliphatic aldehydes such as formaldehyde, acetoaldehyde, propionaldehyde, n-butyl aldehyde and isobutyl aldehyde; and unsaturated aliphatic aldehydes such as acrolein, crotonaldehyde and methacrolein. Examples of the C₁₋₆ amines include saturated aliphatic amines such as methylamine, dimethylamine, trimethylamine, ethylamine, diethylamine and triethylamine; unsaturated aliphatic amines such as allyamine and diallylamine; and aniline. Any of these reducing materials may be used alone, or two or more selected therefrom may be used in combination.

The above-described reduction treatment is usually carried out by subjecting the catalyst to a heat treatment under an atmosphere of a gas which contains the above-described reducing material. The concentration of the reducing material in this gas is usually from 0.1 to 50% by vol., preferably from 3 to 30% by vol. The reducing material may be diluted with nitrogen, carbon dioxide, water, helium, argon or the like, to such a concentration. Preferably, no free oxygen is allowed to be present, although the free oxygen may be present within such a range that the effect of the reduction treatment is not impaired.

The temperature for the reduction treatment (i.e., a heat treatment temperature for the reduction treatment) is preferably from 200 to 600° C., more preferably from 300 to 500° C. The time for the reduction treatment (i.e., a heat treatment time for the reduction treatment) is usually from 5 minutes to 20 hours, preferably from 30 minutes to 10 hours.

Preferably, the above-described reduction treatment is carried out as follows: the calcined material (i.e., the composite oxide catalyst) obtained after the calcination is put in a container of tubular, box-type or the like, and is subjected to a heat treatment while a gas containing the reducing material is being allowed to flow into the container. During this treatment, the gas discharged from the container optionally may be recycled. For example, the catalyst may be packed in a reaction tube for catalytic gas phase oxidation, and a gas containing the reducing material may be allowed to pass through the tube for the reduction treatment, and the catalytic gas phase oxidation may be sequentially carried out.

After the reduction treatment, the mass of the calcined material (i.e., the composite oxide catalyst) obtained after the calcination usually decreases. It is considered that this is because the catalyst would lose lattice oxygen. The rate of decrease in mass due to this reduction treatment (or the heat treatment) is preferably from 0.05 to 6% by mass, more preferably from 0.1 to 5% by mass. When the reduction excessively proceeds with the result that the rate of decrease in mass becomes too high, the catalytic activity, on the contrary, tends to lower. In this case, the catalyst is again calcined under an atmosphere of a free oxygen-containing gas, to thereby lower the rate of decrease in mass. The rate of decrease in mass is determined by the following equation:

the rate of decrease in mass (%)=(the mass of the catalyst found before the reducing treatment−the mass of the catalyst found after the reduction treatment)/the mass of the catalyst found before the reduction treatment×100

In this connection, depending on the type of the reducing material or the conditions for the heat treatment during the reduction treatment, the reducing material itself or a decomposed product derived from the reducing material is likely to remain in the catalyst after the reduction treatment. In such a case, the mass of such a remaining material in the catalyst is separately measured, and this found mass value is subtracted from the mass of the catalyst containing the remaining material; and the mass of the catalyst after the reduction treatment is calculated. Since the remaining material is typically carbon, the mass of the remaining material can be determined, for example, by the measurement of total carbon (TC) or the like.

After the above-described reduction treatment, the catalyst optionally may be again calcined under an atmosphere of a free oxygen-containing gas (this second calcination under the free oxygen-containing gas atmosphere is optionally referred to as “reoxidation”).

The concentration of the free oxygen in the free oxygen-containing gas under which atmosphere the reoxidation is carried out is usually from 1 to 30% by vol., preferably from 10 to 25% by vol. As a free oxygen source, an air or pure oxygen is usually used. This oxygen source is optionally diluted with nitrogen, carbon dioxide, water, helium, argon or the like, for use as the free oxygen-containing gas. The reoxidation temperature is usually from 200 to 600° C., preferably from 350 to 550° C. The reoxidation time is from 5 minutes to 20 hours, preferably from 30 minutes to 10 hours.

In the composite oxide catalyst-producing method of the present invention, the catalyst is optionally subjected to a molding process. The molding process may be carried out according to a conventional method, for example, tablet compression or extrusion molding, to obtain a ring-shaped, pellet-like, spherical or granulated catalyst. The molding process may be carried out before the drying, the calcination or the reduction treatment, or after the reduction treatment. Inorganic fibers or the like substantially inactive to the intended reaction may be added to the catalyst in the molding process, in order to improve the mechanical strength of the catalyst.

The composite oxide catalyst-producing method of the present invention is intended to provide at least one composite oxide catalyst selected from the group consisting of a catalyst for production of unsaturated aldehyde and unsaturated carboxylic acid, a catalyst for production of unsaturated carboxylic acid, a catalyst for production of unsaturated nitrile and a catalyst for a hydrotreatment. Above all, the composite oxide catalyst-producing method of the present invention is suitably employed to produce a catalyst for production of unsaturated aldehyde and unsaturated carboxylic acid.

As the catalyst for production of unsaturated aldehyde and unsaturated carboxylic acid, there is exemplified a catalyst for production of acrolein and acrylic acid by way of catalytic gas phase oxidation of propylene with free oxygen, or a catalyst for production of methacrolein and methacrylic acid by way of catalytic gas phase oxidation of isobutylene or tertiary butyl alcohol with free oxygen. As the catalyst for production of unsaturated carboxylic acid, there is exemplified a catalyst for production of acrylic acid by way of oxidation of acrolein with free oxygen or a catalyst for production of methacrylic acid by way of oxidation of methacrolein with free oxygen. As the catalyst for production of unsaturated nitrile, there is exemplified a catalyst for production of acrylonitrile by way of ammoxidation of propylene with free oxygen or a catalyst for production of methacrylonitrile by way of ammoxidation of isobutylene or tertiary butyl alcohol with free oxygen. As the catalyst for the hydrotreatment, there are exemplified a catalyst for removing a sulfur compound and/or a nitrogen compound in a petroleum fraction or lowering the concentration thereof by reacting such a sulfur compound and/or such a nitrogen compound with hydrogen, and/or a catalyst for hydrogenolysis for use in lightening of heavy oil.

### EXAMPLES

Hereinafter, the present invention will be described in more detail by way of Examples thereof, which however should not be construed as limiting the scope of the present invention in any way.

The activities of the catalysts in the following Examples were evaluated by the method set forth below.

### Catalytic Activity Test

A glass reaction tube with an inner diameter of 18 mm was charged with a catalyst (1 g), and a gas mixture of isobutylene/oxygen/nitrogen/steam (=1/2.2/6.2/2.0 in molar ratio) was fed into the reaction tube at a flow rate of 87.5 mL/min. (Standard Temperature and Pressure), to carry out an oxidation reaction at 350° C. for one hour. A gas from the outlet of the tube (i.e., a gas obtained after the reaction) was analyzed by gas chromatography, and a conversion of isobutylene, and a total selectivity for methacrolein and methacrylic acid were calculated according to the following formulae. Standard Temperature and Pressure hereinafter means 0° C. (273.15K) and 1 atm (101, 325 Pa).

A conversion (%) of isobutylene=[(the number of moles of fed isobutylene)−(the number of moles of unreacted isobutylene)]+(the number of moles of fed isobutylene)×100

A total selectivity (%) for methacrolein and methacrylic acid=(the number of moles of methacrolein and methacrylic acid)+[(the number of moles of fed isobutylene)−(the number of moles of unreacted isobutylene)]

### Production Example 1

### Preparation of Composite Oxide Catalyst Containing Molybdenum and Cobalt

Ammonium molybdate [(NH₄)₆Mo₇O₂₄.4H₂O] (441.4 parts by mass) was dissolved in hot water (500 parts by mass) to obtain a solution A. On the other hand, iron nitrate (III) [Fe(NO₃)₃.9H₂O] (202.0 parts by mass), cobalt nitrate [Co(NO₃)₂.6H₂O] (436.6 parts by mass) and cesium nitrate [CsNO₃] (19.5 parts by mass) were dissolved in hot water (200 parts by mass), and then, bismuth nitrate [Bi(NO₃)₃.5H₂O] (97.0 parts by mass) was dissolved in the resulting solution to obtain a solution B.

Next, the solution A was stirred, and the solution B was added to the solution A to obtain slurry. Then, this slurry was dried at 250° C. with a flash drier, to obtain a catalyst precursor. To this catalyst precursor (100 parts by mass) were added silica alumina fibers (RFC400-SL manufactured by ITM ASSOCIATES) (18 parts by mass) and antimony trioxide [Sb₂O₃] (2.54 parts by mass); and the resulting mixture was molded into a ring-shaped material with an outer diameter of 6.3 mm, an inner diameter of 2.5 mm and a length of 6 mm. This molded material was calcined at 545° C. for 6 hours under a stream of an air, to obtain a composite oxide catalyst (a) containing molybdenum and cobalt.

This catalyst (a) was found to contain bismuth (0.96 atom), antimony (0.48 atom), iron (2.4 atoms), cobalt (7.2 atoms), cesium (0.48 atom), silicon (4.4 atoms) and aluminum (4.8 atoms) per molybdenum (12 atoms).

### Example 1

### Recovery of Molybdenum and Cobalt

The composite oxide catalyst (a) (2,000 g) (which contained 34.6% by mass of molybdenum, 40% by mass of iron, 12.8% by mass of cobalt and 1.9% by mass of cesium) was ground and was then mixed into water (4,000 g) and a 25% by mass aqueous ammonia solution (5,440 g). This mixture was stirred for 15 hours while the liquid temperature of the mixture was being kept at 40° C., and was then filtered under reduced pressure. The resulting filtrate was subjected to a heat treatment at 420° C. in an air for 2 hours, to obtain a solid material (1,064 g) as a recovered material.

A part of the solid material was subjected to an elemental analysis with a X-ray fluorescence spectrometer (ZSX Primus II manufactured by Rigaku Innovative Technologies). As a result, it was found to contain 49.30% by mass of molybdenum, 0.01% by mass of iron, 18.40% by mass of cobalt and 3.15% by mass of cesium. Therefore, the recoveries of the respective elements from the composite oxide catalyst (a) were 75.7% in molybdenum, 0.1% in iron, 76.7% in cobalt and 87.4% in cesium.

The recovery (%) of each element was calculated by the equation: (x/y)×100, wherein x represents the mass (g) of the element in the resultant solid material; and y represents the mass (g) of the element in the composite oxide catalyst (a).

### Evaluation of Recovered Molybdenum and Cobalt

The material (or solid) thus recovered was used for preparation of a composite oxide catalyst containing molybdenum and cobalt, and the catalytic activity of the catalyst was evaluated.

The recovered material (or solid) (50.0 parts by mass) thus obtained was added to an aqueous solution of ammonium molybdate [(NH₄)₆Mo₇O₂₄.4H₂O] (14.5 parts by mass) in water (100.0 parts by mass), to obtain a solution C. On the other hand, iron nitrate (III) [Fe(NO₃)₃.9H₂O] (27.4 parts by mass), cobalt nitrate [Co(NO₃)₂.6H₂O] (13.8 parts by mass) and cesium nitrate [CsNO₃] (0.3 parts by mass) were dissolved in hot water (25.0 parts by mass), and then, bismuth nitrate [Bi(NO₃)₃.5H₂O] (13.2 parts by mass) was dissolved in the resulting solution to obtain a solution D.

Next, the solution C was stirred, and the solution D was added to the solution C to obtain slurry. Then, this slurry was transferred to a stainless steel container and was dried at 250° C. with a box-type drier, to obtain a catalyst precursor. This catalyst precursor was made into tablets under a pressure of about 40 MPa; and the resulting tablets were grounded and were then allowed to pass through a sieve with a sieve opening of from 2 mm to 710 μm, to obtain granules with a grain size of from 2 mm to 710 μm. This granulated catalyst precursor was calcined at 525° C. for 6 hours under a stream of an air, to obtain a calcined material. Then, this calcined material (10.00 g) was charged in a glass reaction tube and was subjected to a reduction treatment at 375° C. for 8 hours, while a gas mixture of hydrogen/steam/nitrogen (=5/10/85 in molar ratio) was being fed into the reaction tube at a flow rate of 200 mL/min. (Standard Temperature and Pressure). The rate of decrease in mass due to this reduction treatment was 0.7%. After that, the reduced material was reoxidized at 350° C. for one hour under a stream of an air. Thus, a composite oxide catalyst (1) was obtained, using the recovered molybdenum and cobalt.

The resultant catalyst (1) was found to contain bismuth (0.96 atom), iron (2.4 atoms), cobalt (7.2 atoms) and cesium (0.48 atom) per molybdenum (12 atoms).

The catalytic activity of this catalyst (1) was evaluated according to the above-described catalytic activity test. As a result, the conversion of isobutylene was 45.5%, and the total selectivity for methacrolein and methacrylic acid was 87.7%.

### Reference Example 1

To confirm an influence of the use of the recovered molybdenum and cobalt on the catalytic activity of the catalyst, a catalyst with the same composition as that of the above-described catalyst (1) was prepared, using new materials, and the catalytic activity of the catalyst was measured.

That is, the same solution A as used in Production Example 1 was stirred, and the same solution B as used in Production Example 1 was added to obtain slurry. Then, this slurry was transferred to a stainless steel container and was dried at 250° C. with a box-type drier, to obtain a catalyst precursor. This catalyst precursor was made into tablets under a pressure of about 40 MPa; and the resulting tablets were grounded and were then allowed to pass through a sieve with a sieve opening of from 2 mm to 710 μm, to obtain granules with a grain size of from 2 mm to 710 μm. This granulated catalyst precursor was calcined at 525° C. for 6 hours under a stream of an air. Thus, a composite oxide catalyst (R1) containing molybdenum and cobalt was prepared, using the new materials.

The resultant catalyst (R1) was found to contain bismuth (0.96 atom), iron (2.4 atoms), cobalt (7.2 atoms) and cesium (0.48 atom) per molybdenum (12 atoms).

The catalytic activity of this catalyst (R1) was evaluated according to the above-described catalytic activity test. As a result, the conversion of isobutylene was 44.4%, and the total selectivity for methacrolein and methacrylic acid was 86.5%.

### Comparative Example 1

A recovering experiment was conducted as follows, using the composite oxide catalyst (a), under the same conditions as those for Example 1 of Patent Publication 2 (International Laid-Open Publication No. 2007/032228). That is, the composite oxide catalyst (a) (300 parts by mass) was dispersed in pure water (1,200 parts by mass), and a 45% by mass aqueous sodium hydroxide solution (400 parts by mass) was added to this dispersion. The resulting mixture was stirred at 60° C. for 3 hours, and then, insoluble materials were removed by filtration, to obtain an aqueous solution containing catalyst components. To this aqueous solution was added a 36% by mass of hydrochloric acid to adjust the pH of the solution to 1.0. After that, the solution was maintained at 30° C. for 3 hours while being stirred. A precipitate thus formed was separated by filtration and was rinsed with a 2% by mass aqueous ammonium nitrate solution to obtain a precipitate (53.2 parts by mass) containing catalytic components.

A part of the precipitate was subjected to an elemental analysis in the same manner as in Example 1. As a result, the precipitate was found to contain 60.1% by mass of molybdenum, 0.7% by mass of cobalt and 6.3% by mass of cesium. Therefore, the recoveries of the respective elements from the composite oxide catalyst (a) were 30.8% in molybdenum, 1.0% in cobalt and 57.8% in cesium.

1. A method for recovering molybdenum and cobalt, characterized in that a composite oxide containing molybdenum and cobalt is mixed with an aqueous extracting solution obtained by dissolving at least one of ammonia and an organic base in water, to thereby extract, from the composite oxide, molybdenum and cobalt into an aqueous phase.

2. The recovering method of claim 1, wherein said composite oxide contains cesium together with molybdenum and cobalt, and wherein the cesium is also extracted into the aqueous phase.

3. The recovering method of claim 1, wherein the pH of said aqueous extracting solution is 8 or more.

4. The recovering method of claim 1, wherein a temperature for mixing said composite oxide with said aqueous extracting solution is from 0 to 100° C.

5. The recovering method of claim 1, wherein said organic base is at least one of an amine or a quaternary ammonium compound.

6. A method for producing a composite oxide which contains molybdenum and cobalt, characterized in that the aqueous phase containing molybdenum and cobalt, obtained by the recovering method defined in claim 1, is dried and is then calcined.

7. A method for producing a composite oxide catalyst which contains molybdenum and cobalt and which is at least one composite oxide catalyst selected from the group consisting of a catalyst for production of unsaturated aldehyde and unsaturated carboxylic acid, a catalyst for production of unsaturated carboxylic acid, a catalyst for production of unsaturated nitrile, and a catalyst for hydrotreatment, characterized in that the molybdenum and cobalt contained in the aqueous phase obtained by the recovering method defined in claim 1 are used as raw materials for the catalyst; and in that an aqueous solution or aqueous slurry, containing said raw materials for the catalyst, is dried and is then calcined.

8. The production method of claim 7, for a catalyst for production of unsaturated aldehyde and unsaturated carboxylic acid.

9. The production method of claim 7, wherein, after the calcination, the resulting catalyst is subjected to a heat treatment in the presence of a reducing material.

10. The production method of claim 9, wherein said heat treatment is carried out at a temperature of from 200 to 600° C.

11. The production method of claim 9, wherein a rate of decrease in mass attributed to said heat treatment is from 0.05 to 6% by mass.

12. The production method of claim 9, wherein said reducing material is selected from the group consisting of hydrogen, ammonia, carbon monoxide, C₁₋₆ hydrocarbons, C₁₋₆ alcohols, C₁₋₆ aldehydes and C₁₋₆ amines.
